(19) United States
(12) Patent Application Publication
(10) Pub. No.: US 2016/0355338 A1
(43) Pub. Date: Dec. 8, 2016

(54) CARRIER CONTROL DEVICE AND CARRIER CONTROL SYSTEM

(71) Applicant: HITACHI, LTD., Tokyo (JP)

(72) Inventors: Yoriko KAZAMA, Tokyo (JP); Junichi KIMURA, Tokyo (JP)

(21) Appl. No.: 15/117,464

(22) PCT Filed: Feb. 18, 2014
(86) PCT No.: PCT/JP2014/053784

§ 371 Date: Aug. 9, 2016

(51) Int. Cl. B65G 1/137; B65G 1/10; G05D 1/02; B65G 1/04

(52) U.S. Cl. CPC B65G 1/137; B65G 1/0492; B65G 1/10; G05D 1/0274; B65G 1/1378; G05D 2201/0216

(57) ABSTRACT

A carrier control device estimates an amount of time to complete a picking operation at each of one or more racks which have arrived in a picking point area. The carrier control device adds up the amounts of time to perform picking operations at the racks performed after another rack has newly arrived, to thereby calculate an amount of time to wait for picking operation completion by the rack. The carrier control device compares the amount of time to wait for picking operation completion by the rack, with a previously set threshold, and determines which task the carrier having carried the rack is to perform, either putting down the rack and performing another task, or waiting for completion of an ongoing picking operation with the rack held thereon, depending on whether the time to wait until picking operation completion is larger or smaller than the threshold.

### CROSS REFERENCE TO RELATED APPLICATION

This application is a National Stage Application of PCT/JP 2014/053784 filed on Feb. 18, 2014, which application is incorporated herein by reference. To the extent appropriate, a claim of priority is made to the above disclosed application.

### TECHNICAL FIELD

The present invention relates to a technique of controlling travel of a carrier which carries an item housed in a warehouse and subjected to a picking operation, so as to efficiently perform the picking operation.

### BACKGROUND ART

When a number of items are housed in a warehouse, techniques of creating a database of positions of the items housed in the warehouse and making it easy to retrieve a position of a housed item to be picked have been disclosed.

Japanese Patent No. 5,377,961 (which may also be hereinafter referred to as Patent Document 1), for example, discloses that, in picking a target item in a warehouse, a carrier carries an entire rack in which the target item is housed to an operation position, at which an operator stands by and can readily pick the item, instead of travel of the operator to the housing position.

### RELATED ART DOCUMENT

### Patent Document

Patent Document 1: Japanese Patent No. 5,377,961

### SUMMARY OF THE INVENTION

### Problem to be Solved by the Invention

The technique disclosed in Patent Document 1 assumes, however: that after the carrier carries the rack to the operation position, while the operator performs a picking operation of the target item, the carrier waits for completion of the picking operation with the rack held thereon; and after the picking operation is completed, the rack is carried away (see paragraphs 0029 and 0030).

When the operator is required to pick a large number of items from a rack, it takes a long time to perform a picking operation at the rack. The technique disclosed in Patent Document 1 has a possibility of a poor operation rate of the carrier, because the carrier stands by with the rack held thereon, while the operator is performing the picking operation. If the number of pickings is required to be increased with such a poor operation rate of the carrier, it is necessary to increase the number of the carriers. This disadvantageously results in a high introduction cost of the carriers.

In light of the described above, the present invention has been made in an attempt to provide a carrier control device and a carrier control system, each of which can efficiently control travel of the carrier, taking into account an amount of time to complete a picking operation.

### Means for Solving the Problem

A carrier control system includes: a carrier control device; and a carrier. The carrier control device includes: a picking time estimation unit that is configured to calculate an amount of time to complete a picking operation, the time to complete a picking operation being an estimated amount of time it takes to pick one or more items from one or more racks which have arrived in a prescribed area, and estimate an amount of time to wait until picking operation completion by a first rack, the first rack being one of the one or more racks, using the time to complete a picking operation at the one or more racks; a task determination unit that is configured to compare the time to wait until picking operation completion by the first rack, with a previously set threshold, and determine which task the carrier having carried the first rack is to perform, either a task of putting down the first rack and performing another task, or a task of waiting for completion of an ongoing picking operation with the first rack held thereon, depending on whether the time to wait until picking operation completion by the first rack is larger or smaller than the threshold; and a task instruction information transmission unit that is configured to transmit the task instruction information to a carrier which has carried the rack of interest. The carrier is configured to receive the task instruction information and perform a task based on the received task instruction information.

The present invention makes it possible to efficiently control travel of a carrier, taking into account an amount of time to complete a picking operation.

### BRIEF DESCRIPTION OF THE DRAWINGS

FIG. 1 is a diagram illustrating a configuration example of a carrier control system including a carrier control device.

FIGS. 2A and 2B are each a perspective diagram illustrating a state in which a carrier loads and unloads a rack, respectively. FIG. 2A illustrates the state in which the carrier lifts up and loads the rack thereon. FIG. 2B illustrates the state in which the carrier unloads the rack therefrom.

FIG. 3 is a diagram illustrating an example of functions of the carrier control system including the carrier control device according to a first embodiment.

FIG. 4 is a diagram illustrating an example of item information.

FIG. 5 is a diagram illustrating a waiting time it takes to wait for completion of a picking operation.

FIG. 6 is a flowchart illustrating an example of a processing flow of the carrier control system according to the first embodiment.

FIG. 7 is a flowchart illustrating an example of a processing flow in which the carrier control device determines a task to be performed by the carrier.

FIG. 8 is a diagram illustrating an example of functions of a carrier control device according to a second embodiment.

FIG. 9 is a schematic diagram illustrating an example of an estimated time to complete a picking operation at a rack and an actual picking execution time at the rack according to the second embodiment.

FIG. 10 is a diagram illustrating an example of functions of a carrier control system according to a third embodiment.

FIG. 11 is a flowchart illustrating an example of a processing flow of the carrier control system according to the third embodiment.

### EMBODIMENTS FOR CARRYING OUT THE INVENTION

Embodiments for carrying out the present invention (each of which may also be hereinafter referred to as “this embodiment”) is described in detail with reference to related drawings.

### <Outline>

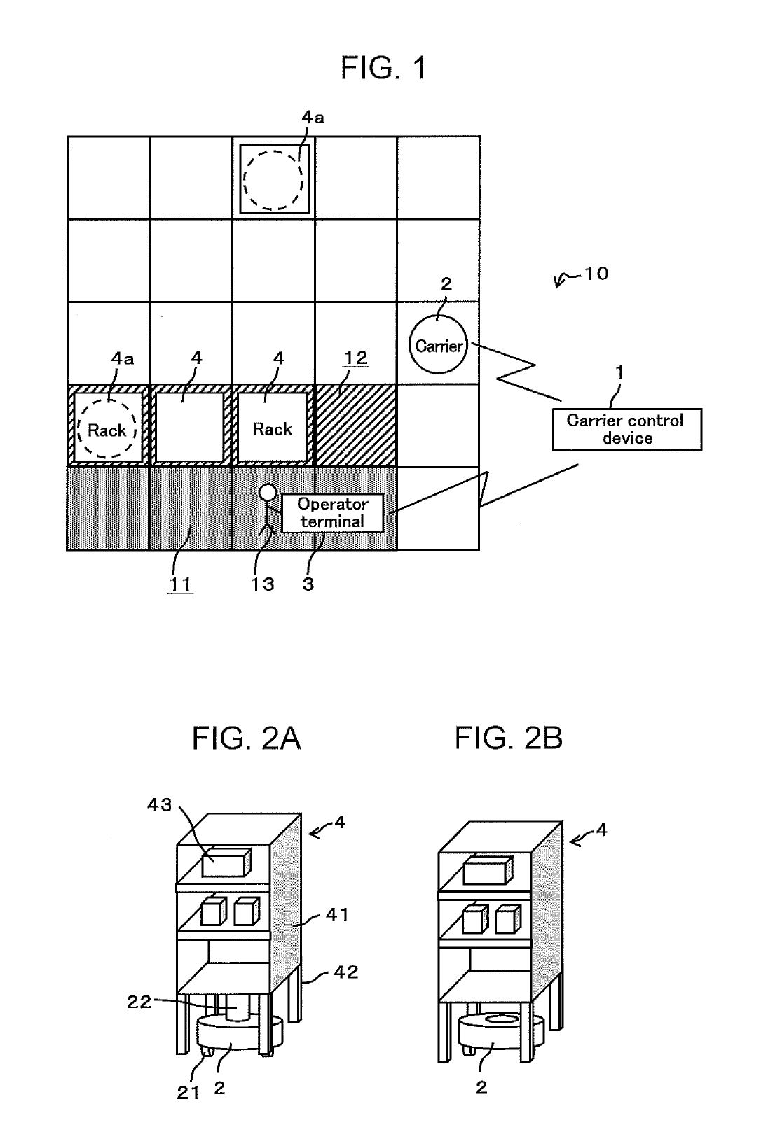

A carrier control system 10 is outlined first. FIG. 1 is a diagram illustrating a configuration example of the carrier control system 10 including a carrier control device 1. The carrier control system 10 includes, in addition to the carrier control device 1, a carrier 2 and an operator terminal 3. The carrier control device 1 and the carrier 2, and the carrier control device 1 and the operator terminal 3 are communicably coupled to each other by radio.

FIG. 1 is a plan diagram of a part of a warehouse. As illustrated in FIG. 1, the warehouse includes a dotted operation area 11 and a diagonally-shaded picking point area 12. The picking point area 12 is an area into which the carrier 2 carries a specified rack 4. The operation area 11 is an area at which an operator 13 picks (takes) an item 43 from the rack 4 carried into the picking point area 12. The picking point area 12 is thus situated adjacent to the operation area 11. In FIG. 1, the carrier 2 is represented by a circle, and the rack 4, a rectangle. Note that a rack 4a is represented by a rectangle with a circle with a broken line, indicating that the rack 4a is being lifted up or carried by the carrier 2.

The carrier 2 can install the rack 4 in the picking point area 12 by putting down the rack 4 on a floor in the picking point area 12. The carrier 2 can move the rack 4 from the picking point area 12 by lifting up the rack 4 and travel with the rack 4 loaded thereon.

How the carrier 2 loads and unloads the rack 4 is described with reference to FIG. 2A and FIG. 2B.

FIG. 2A is a perspective diagram illustrating a state in which the carrier 2 lifts up and loads the rack 4 thereon. The rack 4 has, in an upper portion thereof, a housing part 41 in which the item 43 to be picked is housed. The rack 4 has, in a lower portion thereof, four legs 42 which support the housing part 41 when the rack is put down on the floor by the carrier 2.

The carrier 2 has: a support 22 for lifting up or putting down the rack 4; and one or more wheels 21 for travelling. The support 22 can be extended or shortened in a vertical direction. The carrier 2 can travel underneath the housing part 41 of the rack 4, at which the support 22 is extended upward and can thus lift up the rack 4. The carrier 2 then moves with the rack 4 lifted up thereon and can carry the rack 4. Note that the carrier 2 may include, instead of the support 22, one or more carrier legs (not shown) equipped with one or more wheels 21. The rack 4 can be lifted up or put down by extending or shortening the one or more carrier legs.

The carrier 2 can pivot or turn right or left with or without the rack 4 loaded thereon.

FIG. 2B is a perspective diagram illustrating a state in which the carrier 2 puts down the rack 4 on the floor. As illustrated in FIG. 2B, the carrier 2 having carried the rack 4: shortens the support 22; can thereby put down the rack 4 in the picking point area 12; and can then travel to another place.

Referring back to FIG. 1, when the carrier 2 carries the rack 4 and arrives at the picking point area 12, an operator 13 who is readily waiting for the arrival at the operation area 11 takes the item 43 (see FIG. 2A) from the rack 4. At this time, the operator 13 takes the item 43 based on picking instruction information which is transmitted to an operator terminal 3 carried by the operator 13 in advance. Note that the picking instruction information contains information on the item 43 as a target for picking. The picking instruction information may also contain information indicating an instruction of starting a picking operation. After the picking operation is completed, the rack 4 from which the targeted item 43 has already been picked is moved from the picking point area 12 by the carrier 2.

The carrier control device 1 is configured to estimate (compute), for each rack 4, an amount of time to complete a picking operation and an amount of time to wait until picking operation completion. The time to complete a picking operation used herein means a standard time it takes to pick the item 43 from one rack 4. The time to complete a picking operation varies depending on the number, size, mass, or the like of the item 43 taken from the rack 4 by the operator 13. The time to wait until picking operation completion used herein means, in a case where a plurality of the racks 4 are subjected to respective picking operations of the items 43 at the picking point area 12, a time from when the rack 4 of interest arrives at the picking point area 12 until when the picking operation at the rack 4 of interest is estimated to be completed.

The carrier control device 1 is also configured to determine whether or not the time to wait until picking operation completion is more than a prescribed threshold. The threshold used herein means, for example, a time from when the carrier 2 puts down the rack 4 and again lifts up the rack 4, till when the carrier 2 returns to original position with loaded another rack 41 thereon, or the like. If the carrier control device 1 determines that the time to wait until picking operation completion is larger than the threshold, the carrier control device 1 transmits, to the carrier 2, instruction information such that the carrier 2 puts down the rack 4 of interest and carries another rack 4 instead. This is because, by doing so, the carrier 2 can be used efficiently. In the meantime, if the carrier control device 1 determines that the time to wait until picking operation completion is not larger than the threshold, the carrier control device 1 transmits, to the carrier 2, instruction information such that the carrier 2 carries and holds the rack 4 as it does. The carrier 2 is controlled based on the received instruction information. As described above, the carrier control device 1 can provide efficient control on travel of the carrier 2, depending on the time to wait until picking operation completion.

Next are briefly described respective main functions of the carrier control device 1, the carrier 2, and the operator terminal 3, detailed descriptions of which will be made hereinafter.

The carrier control device 1 is configured to: transmit task instruction information which is information for instructing the carrier 2 to perform a task; and move the rack 4. The task used herein includes, for example: (1) to carry the rack 4 to a destination; (2) to put down rack 4 at the destination; (3) to lift up the rack 4; (4) to travel to the destination without loading the rack 4; and (5) to stand by where it is positioned. The carrier control device 1 is also configured to transmit picking instruction information including information on the item 43 as a picking target, to the operator terminal 3 carried by the operator 13.

The carrier 2 is configured to perform a task instructed from the carrier control device 1. The carrier 2 is also configured to transmit information on where the carrier 2 itself is positioned, to the carrier control device 1. The carrier 2 is further configured to transmit arrival information indicating that the carrier 2 itself has arrived at the picking point area 12, to the carrier control device 1. The carrier control device 1 makes use of the arrival information so as to check which of the carriers 2 and the racks 4 has arrived at the picking point area 12.

The operator terminal 3 is a terminal operated by the operator 13. The operator 13 performs an operation of picking the item 43 housed in the rack 4. At this time, the operator terminal 3 is configured to: receive the picking instruction information from the carrier control device 1 and display the information therein; and transmit picking completion information indicating that the picking operation has been completed, to the carrier control device 1.

Cases as follows are presented and described in the embodiments: (A) in the first embodiment, a case in which travel of the carrier 2 is controlled based on the time to wait until picking operation completion; (B) in a second embodiment, a case in which a task of the carrier 2 is controlled based on an actual picking execution time it takes to actually perform and complete a picking operation; and (C) in a third embodiment, a case in which functions of the carrier control device 1 in the first embodiment is integrated into those of the carrier 2.

### First Embodiment

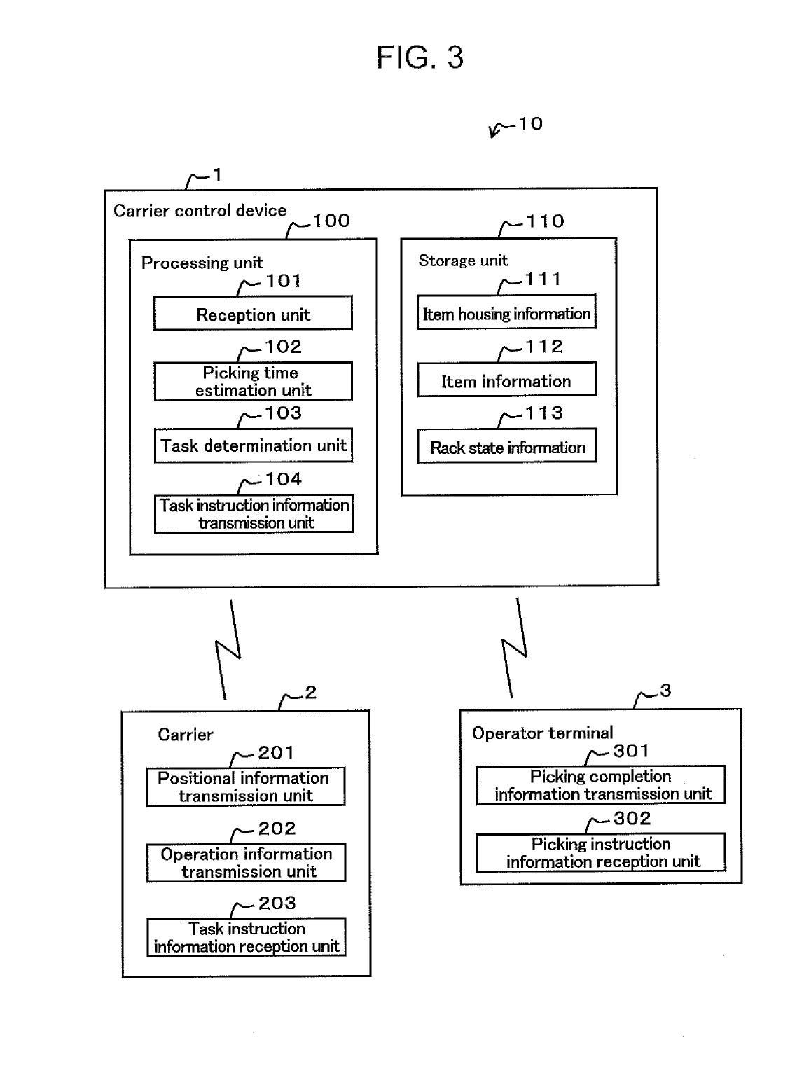

An example of functions of the carrier control system 10 including the carrier control device 1 in the first embodiment is described with reference to FIG. 3 (see also FIG. 1 where appropriate). The example does not contain all of the functions but some main functions essential in explaining the present invention.

The carrier control system 10 includes the carrier control device 1, the carrier 2, and the operator terminal 3. FIG. 1 illustrates one unit of each of the carrier control device 1, the carrier 2, and the operator terminal 3. Alternatively, more than one unit thereof may be provided. When more than one unit of the carrier control devices 1 are provided, the carrier control devices 1 can operate individually, using identification information for identifying each of the carrier control devices 1. When more than one unit of the carriers 2 are provided, the carriers 2 can operate individually, using identification information for identifying each of the carriers 2. When more than one unit of the operator terminals 3 are provided, the operator terminals 3 can operate individually, using identification information for identifying each of the operator terminals 3.

The carrier control device 1 includes a processing unit 100 and a storage unit 110.

The processing unit 100 includes a reception unit 101, a picking time estimation unit 102, a task determination unit 103, and a task instruction information transmission unit 104. The processing unit 100 has a CPU (Central Processing Unit) and a main memory both not shown; and develops an application program stored in the storage unit 110, into the main memory, to thereby embody functions of respective units 101 to 104.

The reception unit 101 is configured to acquire information on the item 43 as a target to be picked, from an external server not shown or an input terminal not shown. The reception unit 101 is also configured to: receive positional information on the carrier 2 from a positional information transmission unit 201 of the carrier 2 with a prescribed period; and receive arrival information indicating that the carrier 2 has arrived at the picking point area 12. The positional information includes, for example, coordinate values (x, y) on a map and a latitude and a longitude. The reception unit 101 is further configured to receive the picking completion information indicating that a picking operation has been completed, from a picking completion information transmission unit 301 of the operator terminal 3.

The picking time estimation unit 102 is configured to: receive the arrival information indicating that the carrier 2 has arrived at the picking point area 12, from the carrier 2 via the reception unit 101; and thereby extract the carrier 2 and the rack 4 of interest which has arrived at the picking point area 12. Note that the picking time estimation unit 102 may acquire information on the arrival of the carrier 2 and the rack 4, based on the positional information of the carrier 2 received via the reception unit 101.

The picking time estimation unit 102 is also configured to calculate the time to complete a picking operation at the rack 4 having been carried by the carrier 2 and the time to wait until picking operation completion by the rack 4. When the items 43 are to be picked out of a plurality of the racks 4 having already arrived at the picking point area 12, the picking time estimation unit 102 calculates the time to wait until picking operation completion, taking into account operation states of all of the racks 4 having already arrived in the picking point area 12. The operation state of the rack 4 herein includes, for example, a state in which a picking operation at the rack 4 has already been finished and a state in which completion of an ongoing picking operation is waited for by the rack 4. The state can be determined by whether or not the picking time estimation unit 102 receives picking completion information indicating that the picking operation has been completed. Details on how to calculate the time to wait until picking operation completion by the rack 4 will be described later.

The task determination unit 103 is configured to determine whether or not the time to wait until picking operation completion by the rack 4 calculated by the picking time estimation unit 102 is more than a prescribed threshold. If the time to wait until picking operation completion by the rack 4 is determined to be more than the threshold, the task determination unit 103: determines that the carrier 2 having carried the rack 4 is to put down the rack 4 in the picking point area 12 and is to perform another task; and creates task instruction information based on the determination. If the time to wait until picking operation completion by the rack 4 is determined to be not more than the threshold, the task determination unit 103: determines that the carrier 2 having carried the rack 4 is to wait with the rack 4 loaded and held thereon, until the picking operation is completed; and creates task instruction information based on the determination.

The threshold is calculated by, for example, Expression (1) as follows:

Threshold=Time taken to load and unload rack 4+Time to perform next task Expression (1)

As the second term of Expression (1) (“Time to perform next task”), an average time thereof based on past actual records may be used, for example.

The task instruction information transmission unit 104 is configured to transmit the task instruction information created by the task determination unit 103, to the carrier 2. If the task instruction information includes an instruction of carrying another rack 4, the task instruction information may contain a route on which the carrier 2 is to carry another rack 4.

The storage unit 110 is a storage such as a hard disk, and may be included in the carrier control device 1 or may be connected thereto from outside. The storage unit 110 stores therein item housing information 111, item information 112, and rack state information 113.

The item housing information 111 includes information on the rack 4 and the item 43 housed in the rack 4 of interest, in association with each other. The picking time estimation unit 102 references the item housing information 111, when the picking time estimation unit 102 computes the time to complete a picking operation at the rack 4.

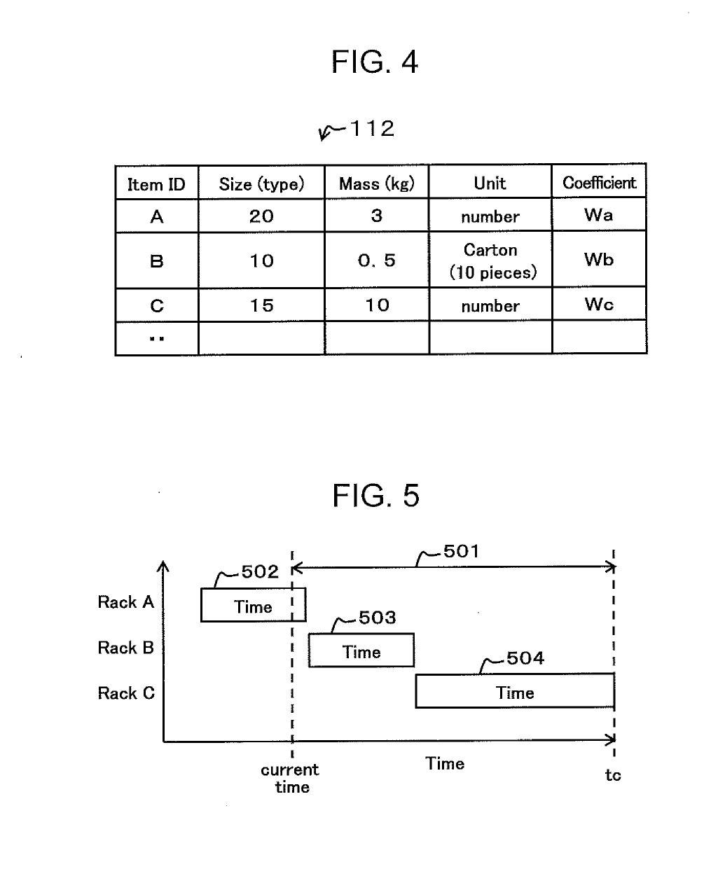

The item information 112 includes information on an item ID, a size (type), a mass (kg), a unit, and a coefficient of the item 43, in association with each other, as illustrated in FIG. 4. The item ID is information for identifying the item 43. The size (type) is information on a type which represents longitudinal, lateral, and height dimensions of the item 43. The unit is the number or the number of cartons or the like. The coefficient represents a weighting used for calculating the time to perform a picking operation.

Next is described calculation of the time to complete a picking operation and the time to wait until picking operation completion, both of which are calculated by the picking time estimation unit 102, with reference to FIG. 4 and FIG. 5.

The time to perform a picking operation varies mainly depending on the size (type), the mass, and the number of the item 43. For example, the time to pick a large-sized item is longer than that to pick a small one. The time to pick a heavy item is longer than that to pick a light one. Thus, the time to complete a picking operation is calculated, for each item ID, by using the size (type) and the mass. For example, in a case where the item ID is “A” and where let Wa a coefficient previously-determined depending on the size (type) and the mass, the time to perform a picking operation of an item having the item ID “A” can be represented by Expression (2) as follows.

Time to perform picking operation of item having item ID “A”=Number of items×Wa Expression (2)

Assume a case, for example, where a time required for picking one unit of an item is five seconds, a time required for two units of the items may be eight seconds. Picking of a plurality of items together can make the time to complete a picking operation shorter than that represented by Expression (2). Such a case can be represented by Expression (3) as follows.

Time to perform picking operation of item having item ID “A”=((Number of items)−1)×Wa d+s1 Expression (3)

Herein, s1 indicates a time to complete a picking operation in which only one item 43 is picked. Wa d indicates a coefficient in the case of picking a plurality of the items 43.

The time to complete a picking operation varies also depending on the unit. In a case where items are held in one carton by the ten pieces, for example, picking may be performed by the carton, or, if too many or too less by the carton, one-by-one picking from a carton may be performed. Such a case can be represented by Expression (4) as follows.

Time to perform picking operation of item having item ID “A”=(Quotient of [number of items/number of items per carton]+Residue of [number of items/number of items per carton])×Wa Expression (4)

Note that the time to complete a picking operation may be calculated, not previously setting a coefficient for each size (type) or mass, but directly using the size (type) and mass. Such a case can be represented by Expression (5) as follows, for example.

Time to perform picking operation=Number of items×(size×mass×conversion coefficient per unit time) Expression (5)

The conversion coefficient per unit time used herein means the size and the mass represented by the unit time.

When a plurality of the items 43 having item IDs different from each other are picked from one rack 4, the time to complete a picking operation is calculated by adding up the times to perform picking operations of respective items having the item IDs.

FIG. 5 exemplifies, in a case where the items 43 are to be picked from three units of the racks 4 (a rack A, a rack B, and a rack C), how to calculate an amount of time to wait until picking operation completion by the rack C 501. In FIG. 5, a time is shown on an abscissa. In FIG. 5, a time when the rack C arrives at the picking point area 12 is shown as a current time. The picking time estimation unit 102 of the carrier control device 1 calculates an amount of time to complete a picking operation of the rack C 504. It is assumed herein that the rack A and the rack B have already arrived at the picking point area 12 in this order, and that respective amounts of time to perform picking operations at the rack A and the rack B (502, 503) have already been calculated.

In FIG. 5, a picking operation at the rack A is performed first, and a start time of the time to complete a picking operation at the rack A 502 is thus determined to be a time when the rack A has arrived at the picking point area 12. An end time of the time to complete the picking operation at the rack A 502 is then set as a start time of the time to complete a picking operation at the rack B 503. Similarly, an end time of the time to complete the picking operation at the rack B 503 is set as a start time of the time to complete a picking operation at the rack C 504. An end time of the time to complete the picking operation at the rack C 504 is thereby estimated as an end time tc of the time to complete the picking operation at the rack C. In sum, the end time tc of the picking operation at the rack C is calculated by adding a total of the times to complete the picking operations at the racks A, B, and C (502, 503, 504), respectively, to the start time of the picking operation at the rack A. The time to wait until picking operation completion by the rack C 501 corresponds to a time from a current time till the end time tc of the picking operation at the rack C and is represented by Expression (6) as follows.

Time to wait for completion of picking operation at rack C=End time tc of picking operation at rack C−Current time Expression (6)

Note that when the item 43 is picked from only one rack 4 having been carried by the carrier 2, a time to wait until picking operation completion by the rack 4 corresponds to a time to complete the picking operation at the rack 4 of interest.

If a plurality of racks 4 to be subjected to respective picking operations have been arriving at the picking point area 12, the picking operations are performed on a first-come-first-served basis.

If priority is given to an order of performing the picking operations, the picking time estimation unit 102 transmits information on the order of performing the picking operations which is made to be contained in the picking instruction information, to the operator terminal 3, such that the rack 4 with higher priority is subjected to an picking operation earlier. Note that the picking time estimation unit 102 may transmit the picking instruction information in accordance with the order of performing the picking operations. The picking time estimation unit 102 computes a time to wait until picking operation completion with the priority order reflected therein.

Referring back to FIG. 3, the rack state information 113 includes information on a position of the rack 4 and an operation state thereof, in association with each other. The operation state at the rack 4 includes, for example, a state in which a picking operation at the rack 4 has already been completed and a state in which completion of the picking operation is waited for by the rack 4. If the picking time estimation unit 102 has already received the picking completion information from the operator terminal 3, the picking time estimation unit 102 determines that the rack 4 is in the state where the picking operation thereat has already been completed. If the picking time estimation unit 102 has not yet received the picking completion information, the picking time estimation unit 102 determines that completion of the picking operation is waited for by the rack 4.

The carrier 2 includes a positional information transmission unit 201, an operation information transmission unit 202, and a task instruction information reception unit 203, as functions thereof.

The carrier 2: includes a CPU and a main memory, both not shown; and develops an application program stored in a storage unit not shown, into the main memory, to thereby embody the functions of respective units 201 to 203.

The positional information transmission unit 201 is configured to transmit positional information which indicates a self-position of the carrier 2, to the carrier control device 1. The self-position is represented by coordinates on a map in a warehouse, for example. If the map is previously designed to express a two-dimensional area in which the carrier 2 travels, for example, a position on the map can be specified using an X-Y coordinate system. Alternatively, a position in a three-dimensional area containing information on the floor may be expressed using an X-Y-Z coordinate system. The self-position on the map can be obtained using any of the following methods (a) to (d):

(a) estimate the self-position by reading a marker or the like arranged in a warehouse;

(b) estimate the self-position by acquiring surrounding conditions using a camera, a sensor, or the like;

(c) estimate the self-position from an image of the carrier 2 itself taken by a camera or the like disposed on a wall, a ceiling, or the like; and

(d) estimate the self-position by integrating traveling tracks of the carrier 2 itself using an odometry or the like.

The positional information transmission unit 201 is also configured to transmit, when the carrier 2 has arrived at the picking point area 12, arrival information indicating the arrival, to the carrier control device 1.

The operation information transmission unit 202 is configured to transmit an operation state of the carrier 2 to the carrier control device 1. The operation state of the carrier 2 includes: (1) a state of carrying the rack 4 to a destination; (2) a state of putting down the rack 4 therefrom; (3) a state of loading the rack 4 thereon; (4) a state of traveling to the destination without loading the rack 4 thereon; and (5) a state of standing by where it is positioned. The operation states are transmitted using prescribed codes for identifying the states.

The task instruction information reception unit 203 is configured to receive the task instruction information transmitted by the task instruction information transmission unit 104 of the carrier control device 1. The carrier 2 performs tasks such as: (1) to carry the rack 4 to a destination; (2) to put down the rack 4 therefrom; (3) to load the rack 4 thereon; (4) to travel to the destination without loading the rack 4 thereon; and (5) to stand by where it is positioned, based on the received task instruction information.

The operator terminal 3 includes the picking completion information transmission unit 301 and a picking instruction information reception unit 302, as functions thereof. The operator terminal 3: has a CPU and a main memory, both not shown; and develops an application program stored in a storage unit not shown, into the main memory, to thereby embody the functions of the respective units 301 to 302.

The picking completion information transmission unit 301 is configured to, when a picking operation is finished, transmit picking completion information indicating that a picking operation at the rack 4 is completed, via the operator 13 to the carrier control device 1.

The picking instruction information reception unit 302 is configured to: receive the picking instruction information transmitted by the picking time estimation unit 102 of the carrier control device 1; and display the received picking instruction information in a display unit thereof (not shown).

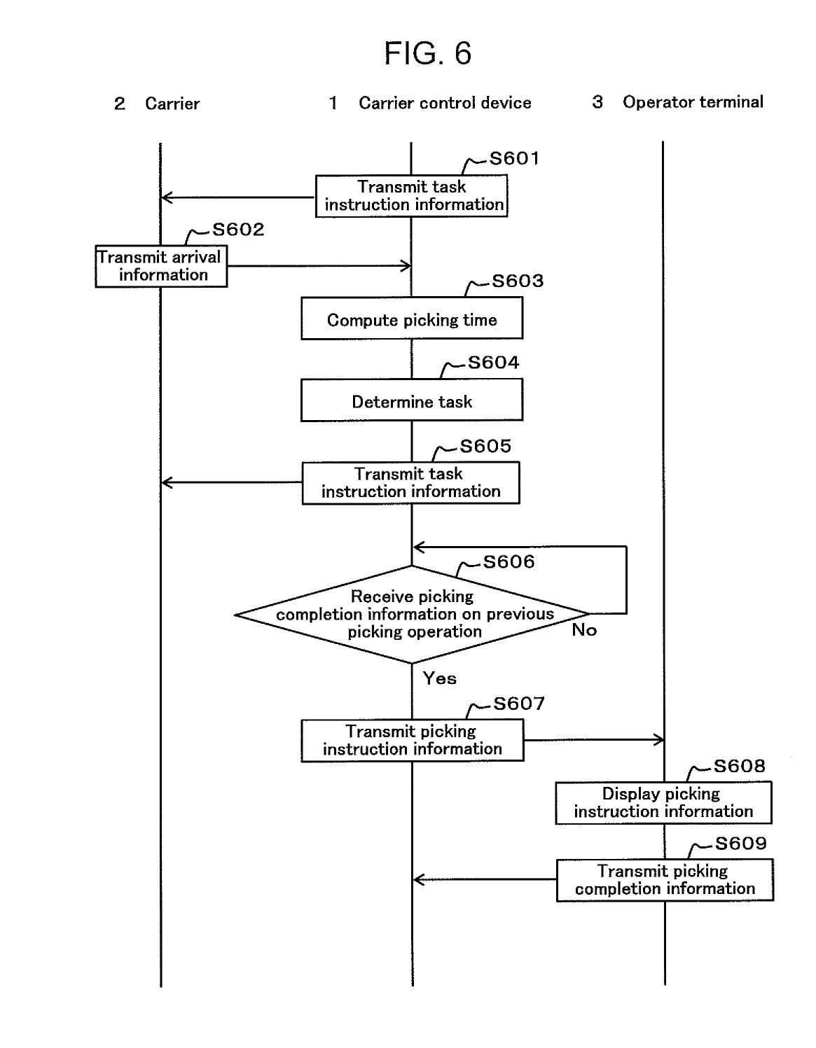

Next is described an example of a processing flow in the carrier control system 10 with reference to FIG. 6 (see also FIG. 3 and FIG. 5 where appropriate).

In step S601, the task instruction information transmission unit 104 of the carrier control device 1 transmits, to the carrier 2, task instruction information for instructing the carrier 2 to carry the rack 4 (specifically, the rack C illustrated in FIG. 5) to the picking point area 12.

In step S602, when the carrier 2 carries the rack 4 (the rack C) and arrives at the picking point area 12 as a destination, the positional information transmission unit 201 transmits the arrival information to the carrier control device 1.

In step S603, the picking time estimation unit 102 of the carrier control device 1 computes a picking time. More specifically, the picking time estimation unit 102: references the item housing information 111 and the item information 112 using the received arrival information; extracts the rack 4 (the rack C) which has already arrived at the picking point area 12; and calculates a time to complete a picking operation at the rack 4 (the rack C) which has been carried by the carrier 2. The picking time estimation unit 102 then computes a time to wait until picking operation completion by the rack 4 (the rack C).

In step S604, the task determination unit 103 of the carrier control device 1 determines a task to be performed by the carrier 2. More specifically, the task determination unit 103 compares the time to wait until picking operation completion with a threshold. The threshold herein is obtained by calculating Expression (1). If the task determination unit 103 determines that the time to wait until picking operation completion is not more than the threshold, the task determination unit 103: determines that the carrier 2 which has carried the rack 4 performs a task of waiting for completion of the picking operation with the rack 4 held thereon; and creates task instruction information for instructing the carrier 2 to perform the determined task. If the task determination unit 103 determines that the time to wait until picking operation completion is more than the threshold, the task determination unit 103: determines that the carrier 2 which has carried the rack 4 performs a task of putting down the rack 4 and leaving therefrom; and creates the task instruction information for instructing the carrier 2 to perform the determined task.

In step S605, the task instruction information transmission unit 104 of the carrier control device 1 transmits the task instruction information created in step S604 to the carrier 2.

In step S606, the picking time estimation unit 102 of the carrier control device 1 determines whether or not the picking completion information on a previous picking operation is received. The previous picking operation used herein means, for example, when the rack C has being carried as in the example illustrated in FIG. 5, a picking operation performed at the rack B.

If the picking completion information is determined to be received (if Yes in step S606), the processing advances to step S607. If the picking completion information is not determined to be received (if No in step S606), the processing returns to step S606.

In step S607, the picking time estimation unit 102 of the carrier control device 1 transmits the picking instruction information on the rack 4 (rack C), to the operator terminal 3. The operator 13 who carries the operator terminal 3 which has received the picking instruction information performs a picking operation, while looking at information on the item 43 as a picking target which is displayed in a display unit (not shown).

In step S608, the picking instruction information reception unit 302 of the operator terminal 3 displays the received picking instruction information in the display unit (not shown).

In step S609, when the picking operation is completed, the picking completion information transmission unit 301 of the operator terminal 3 transmits the picking completion information indicating the completion of the picking operation via the operator 13 to the carrier control device 1.

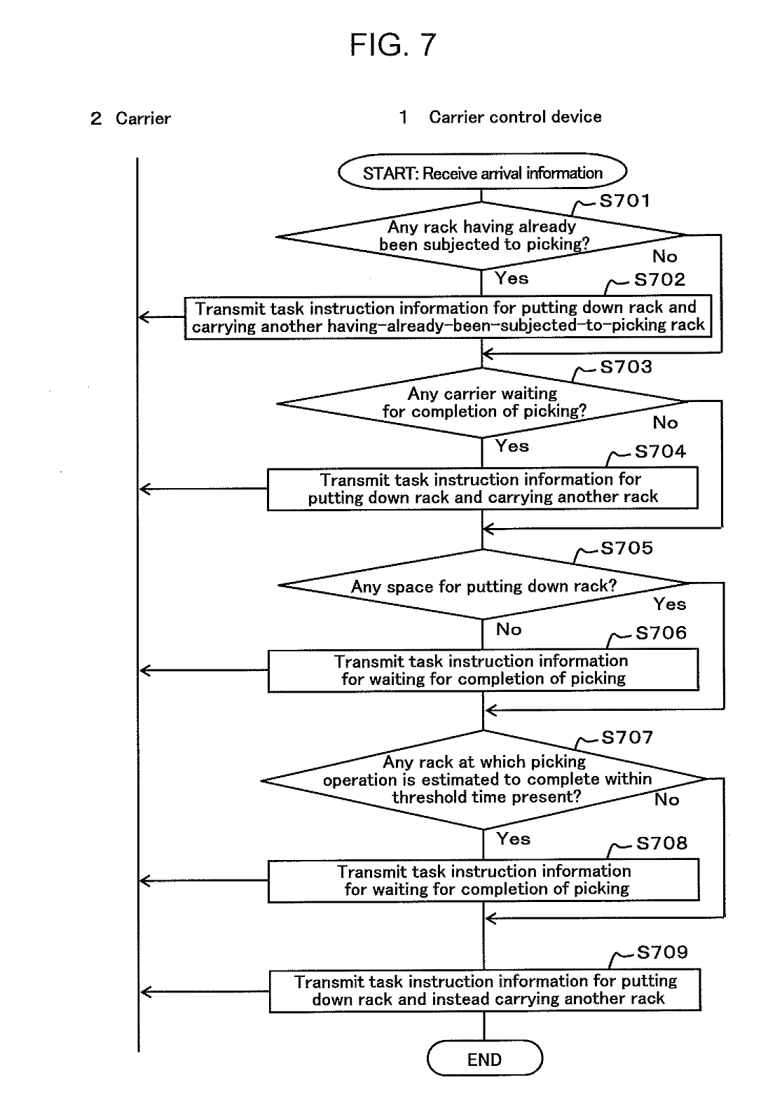

Next is described an example of a processing flow in which the task determination unit 103 of the carrier control device 1 determines a task to be performed by the carrier 2, with reference to FIG. 7. The processing flow starts when the carrier control device 1 receives the arrival information from the carrier 2.

In step S701, the task determination unit 103 determines whether or not the rack 4 which has already been subjected to picking is present in the picking point area 12. Note that, if the picking completion information indicating completion of a picking operation at the rack 4 is received, the rack 4 of interest can be determined to have already been subjected to the picking operation.

If the rack 4 which has already been subjected to picking is determined to be present (if Yes in step S701), the processing advances to step S702. If the rack 4 which has already been subjected to picking is not determined to be present (if No in step S701), the processing advances to step S703.

In step S702, the task determination unit 103: puts down the having-been-carried rack 4 in the picking point area 12; and creates the task instruction information such that the rack 4 at which the picking has already been completed is carried away. The task instruction information transmission unit 104 transmits the created task instruction information to the carrier 2.

In step S703, the task determination unit 103 determines whether or not the carrier 2 which is waiting for completion of a picking operation is present in the picking point area 12.

If the task determination unit 103 determines that the carrier 2 which is waiting for completion of a picking operation is present (if Yes in step S703), the processing advances to step S704. If the task determination unit 103 determines that the carrier 2 which is waiting for completion of a picking operation is not present (if No in step S703), the processing advances to step S705.

In step S704, the task determination unit 103 creates task instruction information for instructing the carrier 2 to put down the rack 4 having been carried by the rack 4 itself in the picking point area 12 and to carry another rack 4. The task instruction information transmission unit 104 transmits the created task instruction information to the carrier 2.

In step S705, the task determination unit 103 determines whether or not space for putting down the rack 4 is present in the picking point area 12.

If space for putting down the rack 4 is determined to be present (if Yes in step S705), the processing advances to step S707. If space for putting down the rack 4 is not determined to be present (if No in step S705), the processing advances to step S706.

In step S706, the task determination unit 103 creates task instruction information for instructing the carrier 2 to wait for completion of a picking operation in the picking point area 12. The task instruction information transmission unit 104 transmits the created task instruction information to the carrier 2.

In step S707, the task determination unit 103 determines whether or not the rack 4 at which the picking operation is estimated to complete within a time to wait until picking operation completion not more than a threshold is present. Note that the threshold is obtained by calculating Expression (1).

If the rack 4 at which the picking operation is estimated to complete within the time not more than the threshold is determined to be present (if Yes in step S707), the processing advances to step S708. If the rack 4 at which the picking operation is estimated to complete within the time not more than the threshold is not determined to be present (if No in step S707), the processing advances to step S709.

In step S708, the task determination unit 103 creates task instruction information for instructing the carrier 2 to wait for completion of the picking operation in the picking point area 12. The task instruction information transmission unit 104 transmits the created task instruction information to the carrier 2.

In step S709, the task determination unit 103 creates task instruction information for instructing the carrier 2 to put down the rack 4 having been carried by the carrier 2 itself in the picking point area 12 and to carry another rack 4. The task instruction information transmission unit 104 transmits the created task instruction information to the carrier 2.

The processing flow illustrated in FIG. 7 makes it possible for the carrier control device 1 to control the carrier 2 such that the carrier 2 can efficiently carry items taking into account a time to complete a picking operation, without unnecessary traveling thereof. The carrier control device 1 also makes it possible for the carrier 2 to, even when a plurality of the racks 4 have been arriving at the picking point area 12, realize a state in which the carrier 2 can enter the picking point area any time.

### Second Embodiment

In the second embodiment, a case is described in which a task performed by the carrier 2 is controlled based on an actual picking execution time it takes to actually perform and complete a picking operation (see FIG. 3 where appropriate).

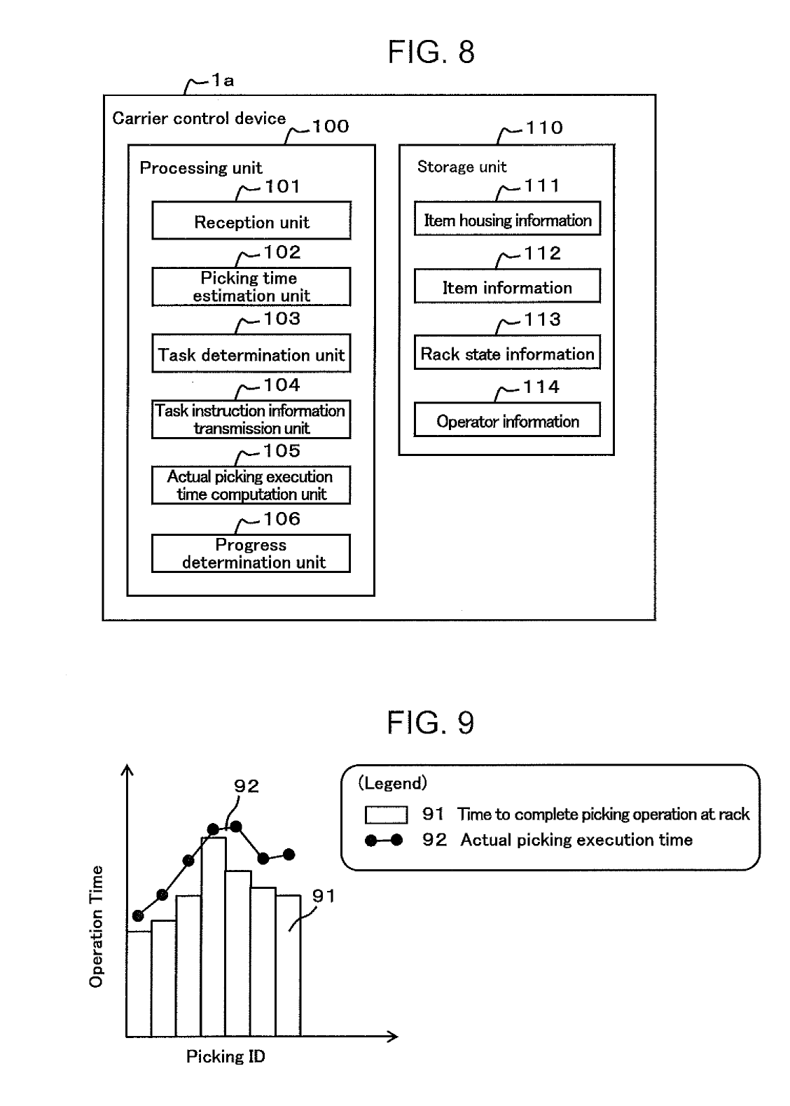

FIG. 8 is a diagram illustrating an example of a carrier control device 1a according to the second embodiment. The carrier control device 1a is similar to the carrier control device 1 according to the first embodiment, except that: the processing unit 100 of the former includes an actual picking execution time computation unit 105, and a progress determination unit 106; and that the storage unit 110 stores therein operator information 114. Description is made focusing on the differences.

The actual picking execution time computation unit 105 is configured to calculate, for each rack 4, an actual picking execution time 92 (see FIG. 9) which is an actual execution time it takes to actually perform and complete a picking operation. When a picking operation is performed at a plurality of the racks 4, the actual picking execution time 92 corresponds to a time between when picking completion information on one picking operation is received and when picking completion information on the previous picking operation is received. In a case where a picking operation is performed for the first time, however, such as the rack A illustrated in FIG. 5, the actual picking execution time 92 is a time from when picking instruction information on the first-performed picking operation is transmitted till when picking completion information thereon is received. Note that, when operation start information is transmitted which is information for reporting a start of a picking operation from the operator terminal 3, the actual picking execution time 92 may be a time from when the operation start information is transmitted till when the picking completion information is received. The actual picking execution time computation unit 105 is configured to store the calculated actual picking execution time 92 in association with an estimated amount of time to complete a picking operation 91 (see FIG. 9) at the rack 4 calculated by the picking time estimation unit 102, in the operator information 114.

The progress determination unit 106 is configured to: reference the operator information 114; compare the time to complete a picking operation 91 and the actual picking execution time 92 at the rack 4; and determine an operation state of the operator 13 from a difference therebetween.

More specifically, the progress determination unit 106: determines an operation state of the operator 13 based on fluctuations of the difference between the time to complete a picking operation 91 and the actual picking execution time 92 at the rack 4; and transmits alerts (1) to (3) as shown below, to an administrator.

(1) When the difference between the time to complete a picking operation 91 and the actual picking execution time 92 at the rack 4 is increased over time, physical conditions of the operator 13 may possibly become poor. The progress determination unit 106 thus transmits an alert of taking a break to the operator terminal 3.

(2) When the difference between the time to complete a picking operation 91 and the actual picking execution time 92 at the rack 4 is decreased over time, the operator 13 may possibly become skillful in picking operations. The progress determination unit 106 thus transmits an alert of further boosting motivation of the operator 13 to the operator terminal 3.

(3) If the difference between the time to complete a picking operation 91 and the actual picking execution time 92 at the rack 4 has wide fluctuations, the operator 13 may possibly become distracted. The progress determination unit 106 thus transmits an alert of raising concentration level of the operator 13 by improving surrounding environment, to the operator terminal 3.

The above described makes it possible for the carrier control device 1a to monitor an operation progress state of the operator 13 and realize effective operation assignment to the operator 13.

The operator information 114 includes, for each operator 13, the time to complete a picking operation 91 and the actual picking execution time 92 at the rack 4, in association with each other.

FIG. 9 illustrates an example of the time to complete a picking operation 91 and the actual picking execution time 92 at the rack 4 for each operator 13 in graphical form. In FIG. 9, a picking operation for each rack 4 is shown on an abscissa; and an operation time, on an ordinate.

The progress determination unit 106 displays the graph as illustrated in FIG. 9 in a display unit (not shown) and can compute picking operation efficiency of the operator 13. More specifically, the progress determination unit 106: calculates, for each operator 13, an average of differences between the times to complete a picking operation 91 and the actual picking execution times 92 at the rack 4; and stores the calculated average in the operator information 114. If, for example, the actual picking execution time 92 at the rack 4 is always smaller than the time to complete a picking operation 91, the picking operation efficiency is determined to be high. If, for example, the actual picking execution time 92 at the rack 4 is always more than the time to complete a picking operation 91, the picking operation efficiency is determined to be low.

Note that the average of differences between the times to complete a picking operation 91 and the actual picking execution times 92 at the rack 4 for each operator 13 may be used in calculating the estimated time to complete a picking operation or the time to wait until picking operation completion by the rack 4. For example, the estimated time to complete a picking operation at the rack 4 can be calculated using the average with Expression (7) as follows.

Time to complete picking operation at rack=Number of items×Wa+β Expression (7)

Herein, β represents an average of differences obtained by, for each operator 13, subtracting the time to complete a picking operation 91 at the rack 4, from the actual picking execution time 92.

This makes it possible for the picking time estimation unit 102 to change the time to complete a picking operation for each operator 13 using Expression (7), based on actual data.

### Third Embodiment

In a third embodiment, a case is described in which functions of the carrier control device 1 according to the first embodiment are integrated into those of the carrier 2. Designated by the reference numeral 10a is a carrier control system; by 2a, a carrier; and by 3a, an operator terminal.

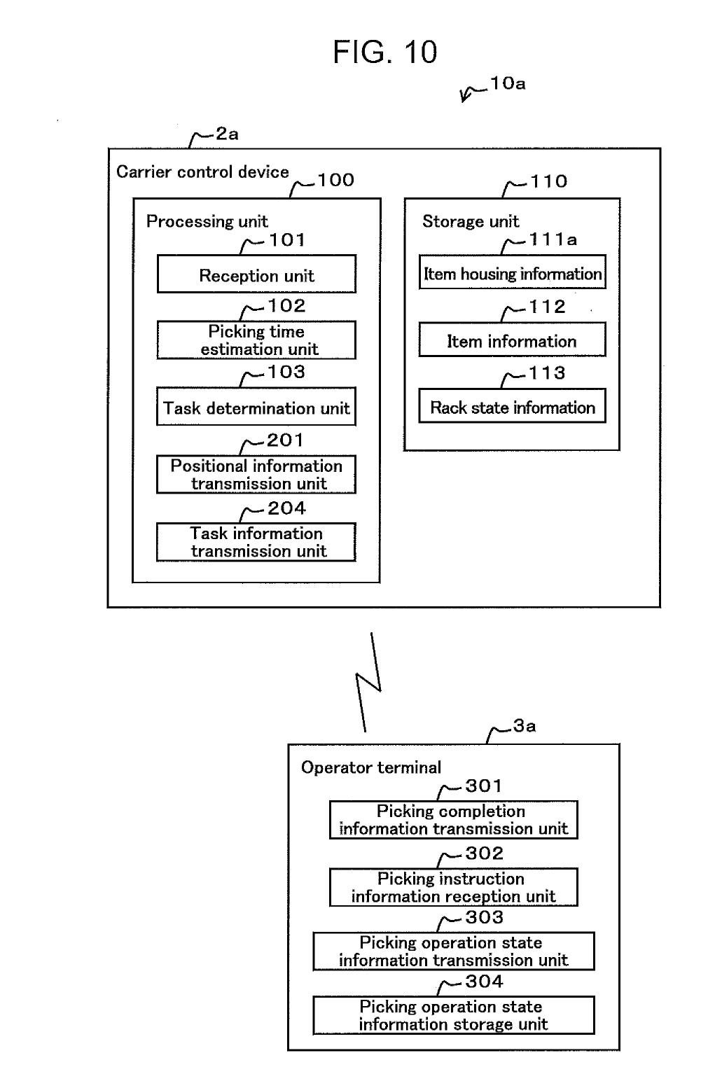

FIG. 10 illustrates an example of functions of the carrier control system 10a according to the third embodiment. The carrier 2a according to the third embodiment has the functions of the carrier control device 1 and part of the functions of the carrier 2 each according to the first embodiment. For example, a communication function between the carrier control device 1 and the carrier 2 by radio is not required in the carrier 2a. Note that in FIG. 10, the same reference numerals are given to the functions similar to those in the first embodiment, and description thereof is omitted herefrom.

Next are described: a task information transmission unit 204 and item housing information 111a, each of which is included in the carrier 2a; and a picking operation state information transmission unit 303 and a picking operation state information storage unit 304, each of which is included in the operator terminal 3a, which are newly provided and illustrated in FIG. 10.

The task information transmission unit 204 of the carrier 2a is configured to transmit task information which is information on a task to be performed by the carrier 2a itself created by the task determination unit 103, to the operator terminal 3a.

The item housing information 111a is, of the item housing information 111 which includes information on the rack 4 and the item 43 housed in the rack 4 in association with each other, information on the rack 4 carried by the carrier 2a itself and the item 43 therein.

The picking operation state information transmission unit 303 of the carrier 2a is configured to: reference the picking operation state information storage unit 304; create picking operation state information which is information on a state of a picking operation in the picking point area 12; and transmit the created picking operation state information to the carrier 2a. Note that the picking operation state information includes: (1) the rack 4 which has arrived at the picking point area 12, other than the rack 4 of interest; (2) information on whether a picking operation at the other rack 4 has already been completed or completion of the picking operation is waited for by the other rack 4; and (3) a time to complete a picking operation at the other rack 4.

The picking operation state information storage unit 304 of the operator terminal 3a stores therein the time to complete a picking operation which has been calculated by the picking time estimation unit 102 of the carrier 2a.

Next is described an example of a processing flow in the carrier control system 10a according to the third embodiment, with reference to FIG. 1 (see FIG. 5 and FIG. 10 where appropriate). Note that in explaining a case where the items 43 are picked from a plurality of the racks 4, description is made using the racks A, B, and C illustrated in FIG. 5 so as to distinguish one rack 4 from the other with a name of the specific rack shown in ( ).

In step S1101, the carrier 2a carries the rack 4 (the rack C illustrated in FIG. 5) and arrives at the picking point area 12.

In step S1102, the positional information transmission unit 201 transmits the arrival information (on the rack C) to the operator terminal 3a.

In step S1103, the picking operation state information transmission unit 303 of the operator terminal 3a transmits the picking operation state information to the carrier 2a.

The picking operation state information includes: (1) the rack 4 (the rack A and the rack B) which has arrived at the picking point area 12 other than the rack 4 of interest; (2) information on whether a picking operation at the other rack 4 (the rack A and the rack B) has already been completed or the other rack 4 is waiting for completion of the picking operation; and (3) a time to complete a picking operation at the other rack 4 (the rack A and the rack B).

In step S1104, the picking time estimation unit 102 calculates a picking time. More specifically, the picking time estimation unit 102 calculates: a time to complete a picking operation at the rack 4 (the rack C) which the carrier 2a has carried; and a time to wait until picking operation completion by the rack 4 of interest (the rack C).

In step S1105, the picking time estimation unit 102 of the carrier 2a transmits the time to complete a picking operation at the rack 4 (the rack C), as a result of the calculation made in step S1104, to the operator terminal 3a.

In step S1106, the operator terminal 3a stores the received time to complete a picking operation at the rack 4 (the rack C), in the picking operation state information storage unit 304.

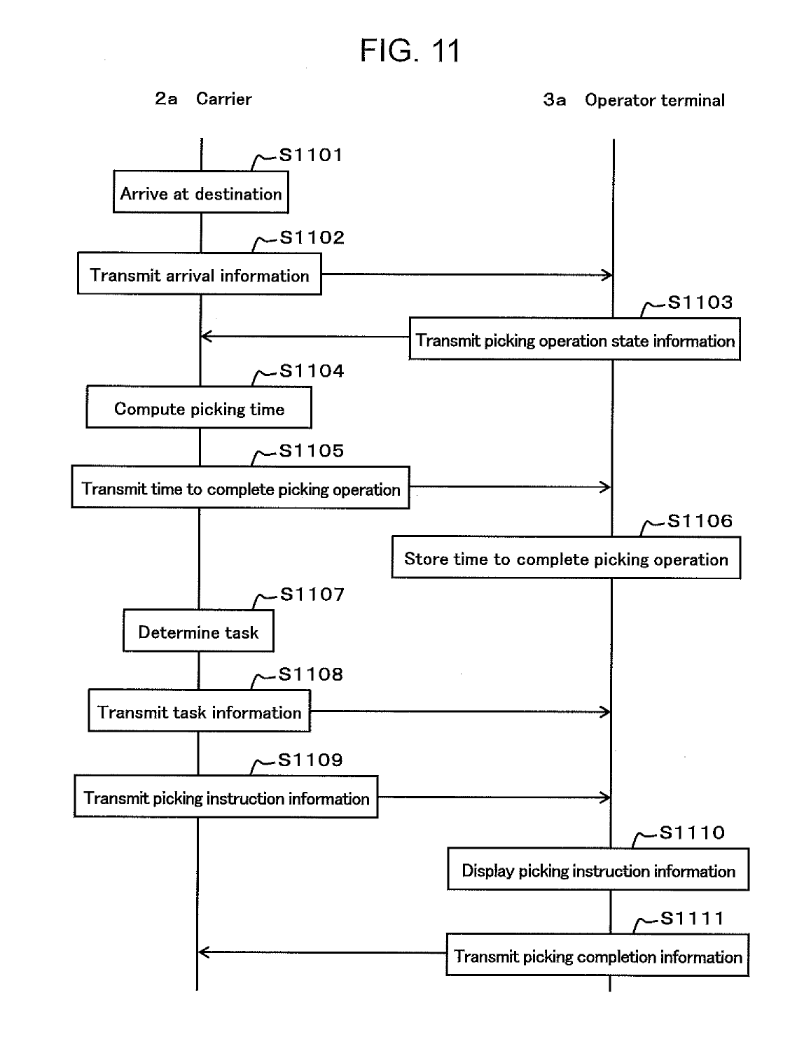

In step S1107, the task determination unit 103 of the carrier 2a: compares the time to complete the picking operation at the rack 4 (the rack C), with the threshold shown in Expression (1) described above; and determines whether the carrier 2a waits for completion of the picking operation with the rack 4 (the rack C) held thereon, or puts down the rack 4 (the rack C) in the picking point area 12 and performs another task (which is described as “Determine task” in FIG. 11).

In step S1108, the task determination unit 103 of the carrier 2 transmits the task information indicating the task determined in step S1107, to the operator terminal 3a.

In step S1109, the picking time estimation unit 102 of the carrier 2a transmits picking instruction information, to the operator terminal 3a. More specifically, in the case where the carrier 2a waits for completion of the picking operation with the rack 4 (the rack C) held thereon, upon receipt of the picking completion information on a previously-subjected-to-picking-operation rack 4 (the rack B), the picking time estimation unit 102 transmits picking instruction information on the rack 4 (the rack C). In another case where the carrier 2a puts down the rack 4 (the rack C) and performs another task, when the picking operation at the previously-handled rack 4 (the rack B) has been completed and, in addition, the carrier 2a has put down the rack 4 of interest (the rack C), the picking time estimation unit 102 transmits the picking instruction information on the rack 4 of interest (the rack C).

In step S1110, the picking instruction information reception unit 302 of the operator terminal 3a displays the received picking instruction information to a display unit (not shown).

In step S1111, when the picking operation has been completed, the picking completion information transmission unit 301 of the operator terminal 3a transmits picking completion information indicating that the picking operation has been completed, via the operator 13 to the carrier 2a.

The processing flow exemplified in FIG. 11 makes it possible to avoid a long-time stand-by state of the carrier 2a in the picking point area 12, thus allowing the carrier 2a to be efficiently operated.

As described above, the carrier control systems (10, 10a) according to the first to third embodiments each calculate a time to complete a picking operation for each rack 4 having arrived in the picking point area 12. The carrier control systems (10, 10a) each: add up the amounts of time to complete picking operations at a plurality of the racks 4 which are subjected to picking operations after arrival of one of a plurality of the racks 4 of interest; and calculate the amount of time to wait until picking operation completion which is a time from when the rack 4 of interest arrives at the picking point area 12 till when the picking operation at the rack 4 of interest is completed. The carrier control systems (10, 10a) each: compare the time to wait until picking operation completion by the rack 4 of interest, with a previously set threshold; and determines which task the carrier 2 having carried the rack 4 of interest is to perform, either a task of putting down the rack 4 of interest and performing another task, or a task of waiting for completion of an ongoing picking operation, with the rack 4 of interest held thereon, depending on whether the time to wait until picking operation completion is larger or smaller than the threshold. This makes it possible for the carrier control systems (10, 10a) to each efficiently control travel of the carrier 2, taking into account the estimated time to complete the picking operation.

Note that in the first embodiment, the time to wait until picking operation completion by the rack C 501 (see FIG. 5) is described as being calculated with Expression (6). As a variation, however, with respect to the rack 4 whose picking completion information has not yet received, the time to wait for picking operation completion by the rack 4 of interest 501 can be calculated as a total value obtained by adding up the amounts of time to complete picking operations at the one or more racks 4 at which picking operations have not yet completed at a current point of time. A specific example is described with reference to FIG. 5. In a case where picking completion information on a picking operation at the rack A has already been received at a current time, the time to wait until picking operation completion by the rack C 501 can be calculated by totaling the estimated time to complete a picking operation at the rack B 503 and the estimated time to complete a picking operation at the rack C 504. In another case where picking completion information on a picking operation at the rack A has not yet been received, the time to wait until picking operation completion by the rack C 501 can be calculated by adding up the estimated time to complete a picking operation at the rack A 502, the estimated time to complete a picking operation at the rack B 503, and the estimated time to complete a picking operation at the rack C 504. This is because a time from when the operator 13 acquires picking instruction information till when the operator 13 actually starts a picking operation based on the picking instruction information varies widely. Until sufficient data on the actual picking execution time of the operator 13 is acquired, a time to wait until picking operation completion can be therefore defined as in the variation.

The present invention is carried out not only by the above-described embodiments but also by variations of many types. the above-described embodiments are intended to be illustrative of the present invention in an easily understandable manner, for example, and the present invention is not limited to the one that includes all of the components explained in the embodiments. Part of a configuration of any of the embodiments of the present invention can be substituted by or added to that of any of the variations. Part of a configuration of any of the embodiments can be deleted.

Part or all of a configuration, a feature, a processing part, a processing unit, or the like can be embodied by hardware by means of, for example, designing of integrated circuits. The above-described configuration, feature, or the like can be embodied by software in which, for example, a processor interprets and executes a program which realizes the feature. Data in a program, a table, a file, and the like for realizing such a feature can be stored in a storage device including a memory, a hard disk, and a SSD (Solid State Drive) or in a storage medium including an IC card, a SD card, and a DVD (Digital Versatile Disc).

In the present invention, only a control line or an information line which are deemed necessary for explanation is illustrated, and not all of them which are necessary in a product are illustrated. In practice, almost all configurations are deemed to be connected to each other.

### DESCRIPTION OF REFERENCE NUMERALS

1, 1a carrier control device
2, 2a carrier
3, 3a operator terminal
4, 4a rack
10, 10a carrier control system
11 operation area
12 picking point area (prescribed area)
13 operator
21 wheel
22 support
41 housing part
42 leg
43 item
91 time to complete a picking operation
92 actual picking execution time
100 processing unit
101 reception unit
102 picking time estimation unit
103 task determination unit
104 task instruction information transmission unit
105 actual picking execution time computation unit
106 progress determination unit
110 storage unit
111 item housing information
112 item information
113 rack state information
114 operator information
201 positional information transmission unit
202 operation information transmission unit
203 task instruction information reception unit
204 task information transmission unit
301 picking completion information transmission unit
302 picking instruction information reception unit
303 picking operation state information transmission unit
304 picking operation state information storage unit
501 time to wait until picking operation completion

1. A carrier control device, comprising:
a picking time estimation unit that is configured to calculate an amount of time to complete a picking operation, the time to complete a picking operation being an estimated amount of time it takes to pick one or more items from one or more racks which have arrived in a prescribed area, and estimate an amount of time to wait until picking operation completion by a first rack, the first rack being one of the one or more racks, using the time to complete a picking operation at the one or more racks; and
a task determination unit that is configured to compare the time to wait until picking operation completion by the first rack, with a previously set threshold, and determine which task the carrier having carried the first rack is to perform, either a task of putting down the first rack and performing another task, or a task of waiting for completion of an ongoing picking operation with the first rack held thereon, depending on whether the time to wait until picking operation completion by the first rack is larger or smaller than the threshold.

2. The carrier control device carrier control device according to claim 1,
wherein, when the one or more racks have already arrived in the prescribed area, and further, when a second rack as another rack has newly arrived in the prescribed area:
the picking time estimation unit calculates a time to complete a picking operation at the second rack, adds up amounts of time to complete picking operations at the one or more racks which have already arrived in the prescribed area, and an amount of time to complete the picking operation at the second rack, and determines the obtained total as an amount of time to wait until picking operation completion by the second rack; and
the task determination unit compares the time to wait until picking operation completion by the second rack, with the threshold, and determines which task the carrier having carried the second rack is to perform, either a task of putting down the second rack and leaving the area, or a task of waiting for completion of an ongoing picking operation with the second rack held thereon, depending on whether the time to wait until picking operation completion by the second rack is larger or smaller than the threshold.

3. The carrier control device according to claim 2, further comprising a reception unit that is configured to receive, from an operator terminal operated by an operator, picking completion information indicating that a picking operation at a rack has been completed,
wherein the picking time estimation unit totals a time to complete a picking operation of a third rack, the third rack being the one or more racks and whose picking completion information has not yet been received, plus the time to complete the picking operation at the second rack, and determines the obtained total as a time to wait until picking operation completion by the second rack.

4. The carrier control device according to claim 2,
wherein the picking time estimation unit: determines a time when a rack which is first subjected to a picking operation arrived in the prescribed area, as a start time of the time to complete a picking operation at the rack; adds amounts of time to complete the picking operations at all of the one or more racks which have arrived in the prescribed area and the second rack, to the start time; determines the added amounts of time as an end time when the picking operation at the second rack is completed; and calculates a difference between the end time and a time when the second rack arrived therein, as a time to wait until picking operation completion by the second rack.

5. The carrier control device according to claim 1,
wherein the picking time estimation unit calculates the time to complete a picking operation at any of the one or more racks, based on a size, a mass, and the number of units of the item to be picked therefrom.

6. The carrier control device according to claim 3, further comprising an actual picking execution time computation unit that is configured to compute a difference obtained by subtracting, from a time when first picking completion information indicating that a picking operation at the rack of interest has been completed, a time when second picking completion information indicating that a picking operation at a previously-subjected-to-picking-operation rack has been completed,
wherein the actual picking execution time computation unit associates the time to complete a picking operation with the difference, for each picking operation of the rack of interest.

7. The carrier control device according to claim 6,
wherein the picking time estimation unit adds, for each operator who performs a picking operation, an average of the differences, to the time to complete a picking operation at the rack of interest, in association with the time to complete a picking operation at the rack of interest and the difference, based on which the picking time estimation unit 102 changes the time to complete a picking operation at the rack of interest.

8. A carrier control system, comprising:
a carrier control device, comprising,
a picking time estimation unit that is configured to calculate an amount of time to complete a picking operation, the time to complete a picking operation being an estimated amount of time it takes to pick one or more items from one or more racks which have arrived in a prescribed area, and estimate an amount of time to wait until picking operation completion by a first rack, the first rack being one of the one or more racks, using the time to complete a picking operation at the one or more racks,
a task determination unit that is configured to compare the time to wait until picking operation completion by the first rack, with a previously set threshold, and determine which task the carrier having carried the first rack is to perform, either a task of putting down the first rack and performing another task, or a task of waiting for completion of an ongoing picking operation with the first rack held thereon, depending on whether the time to wait until picking operation completion by the first rack is larger or smaller than the threshold, and
a task instruction information transmission unit that is configured to transmit the task instruction information to a carrier which has carried the rack of interest; and
the carrier that is configured to receive the task instruction information and perform a task based on the received task instruction information.

9. The carrier control system according to claim 8,
wherein, in the carrier control device, when the one or more racks have already arrived in the prescribed area, and further, when a second rack as another rack has newly arrived in the prescribed area:
the picking time estimation unit calculates a time to complete a picking operation at the second rack, adds up amounts of time to complete picking operations at the one or more racks which have already arrived in the prescribed area, and an amount of time to complete the picking operation at the second rack, and determines the obtained total as an amount of time to wait until picking operation completion by the second rack; and
the task determination unit compares the time to wait until picking operation completion by the second rack, with the threshold, and determines which task the carrier having carried the second rack is to perform, either a task of putting down the second rack and leaving the area, or a task of waiting for completion of an ongoing picking operation with the second rack held thereon, depending on whether the time to wait until picking operation completion by the second rack is larger or smaller than the threshold.
